(19) United States
(12) Patent Application Publication
(10) Pub. No.: US 2007/0060708 A1
(43) Pub. Date: Mar. 15, 2007

(54) Vinyl fluoride-based copolymer binder for battery electrodes

(76) Inventors: Jian Wang, Shizuoka-Shi (JP); Shunsuke Mochizuki, Kohriyama-Shi (JP); Ronald Earl Uschold, West Chester, PA (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/517,109

(22) Filed: Sep. 7, 2006

Related U.S. Application Data
(60) Provisional application No. 60/716,746, filed on Sep. 13, 2005.

(51) Int. Cl. C08L 27/12

(52) U.S. Cl. 525/199

(57) ABSTRACT

A binder for a battery electrode comprising a vinyl fluoride-based copolymer. The vinyl fluoride-based copolymer preferably comprises about 25 to about 85 mol % vinyl fluoride and about 75 to about 15 mol % of at least one other fluorine-containing monomer. In a preferred embodiment, the binder comprises a mixture of at least two types of vinyl fluoride-based copolymers. In another embodiment the binder comprises a vinyl fluoride-based copolymer and at least one other fluorine-based polymer. The binder can be dispersed in water or organic solvent to form a paste for binding electrode materials to current collectors for battery electrode fabrication. Battery electrodes with improved adhesion strength and electrochemical stability result.

### FIELD OF INVENTION

The invention relates to improved fluoropolymer binders for binding electrode materials in the fabrication of battery electrodes.

### BACKGROUND OF THE INVENTION

In a lithium-ion secondary battery, a binder is required to keep the ion and electron conduction in the electrodes stable. At present, polyvinylidene fluoride (PVDF) is typically used for this binder. In the case of PVDF, however, delamination of the active mass (i.e., electrode materials such as lithium composite oxides or carbon) occurs due to insufficient adhesion strength and flexibility, and thus there is a need for the development of new binders for electrodes.

In recent years, along with the development of small electrical devices such as cellular phones and video cameras, there have been active developments of small, light and high-output power supplies. The lithium-ion secondary battery is used widely as a battery meeting these requirements.

In the lithium-ion secondary battery, the anode uses an aluminum foil as the current collector. Powder lithium composite oxide such as LiCoO₂, LiNiO₂ or LiMn₂O₄ is mixed with a conductive material (such as carbon), a binder and a solvent to form a paste, which is coated and dried on the surface of the current collector. The cathode is prepared by coating a paste obtained by mixing carbon, a binder and a solvent onto a copper foil. To fabricate a battery, electrodes are layered in the order of the cathode, a separator (polymer porous film), the anode and a separator and then coiled and housed in a cylindrical or rectangular can. In this battery fabrication process, a binder is a material that is important for bonding the active mass (electrode materials) essential to the battery to the current collector of the electrodes. The adhesive and chemical properties of the binder have a great impact on the performance of the battery. Typically, a combination of polyvinylidene fluoride (PVDF) and N-methyl-2-pyrrolidone (NMP) is used for the binder and the solvent. Polyvinylidene fluoride is soluble in NMP and allows for the preparation of a paste having a proper viscosity. Furthermore, polyvinylidene fluoride shows good chemical resistance and demonstrates bonding capability even in a carbonate-based organic solvent used in the electrolytic solution of a battery.

However, polyvinylidene fluoride does not completely meet all of the binder properties required for batteries. The active mass tends to delaminate or break away from the current collector when coiling the electrodes in the battery fabrication process. Such delamination of the active mass will result in an increase in the internal resistance of the battery, causing a decline in the performance of the battery. For this reason, there is an urgent need to develop a binder that will reduce the delamination of the active mass.

As a means for improving the adhesion strength of a binder, a method in which various functional groups are introduced into the resin used in a binder is reported. For example, it is described in the Japanese Patent No. 3467499 that the adhesion strength of polyvinylidene fluoride was improved from the level of the conventional polyvinylidene fluoride by using a copolymer of vinylidene fluoride and a monomer having an epoxy group.

As an additional example of the improvement of a binder through the use of a copolymer comprising primarily vinylidene fluoride, a copolymer of vinylidene fluoride and hexafluoropropylene, for example, is reported (Japanese Patent No. 3501113). However, while such copolymer comprising primarily vinylidene fluoride shows improved adhesion strength, it tends to swell in a carbonate-based organic solvent used in the electrolytic solution of a battery, causing a decline in the battery capacity in some cases.

Also, it is reported in the Japanese Patent Publication No. 2004-79327 that there was an improvement in adhesion strength when a binder prepared by mixing two kinds of polyvinylidene fluoride having different molecular weight was used. However, in this case, no improvement was made in the hardness of the resin itself because polyvinylidene fluoride was used. Furthermore, it is mentioned in the Japanese Patent No. 3440963 that adhesion strength was improved by using acrylic ester-styrene copolymer in addition to polyvinylidene fluoride. In this case again, however, the fundamental problem of the hardness of the resin remained because of polyvinylidene fluoride-acrylic ester hardness.

Based on the background described above, there is a need for a new binder having improved adhesive properties with chemical resistance to the electrolytic solution and electrochemical stability.

### BRIEF SUMMARY OF THE INVENTION

The invention provides a binder for a battery electrode comprising a vinyl fluoride-based copolymer. The vinyl fluoride-based copolymer preferably comprises about 25 to about 85 mol % vinyl fluoride and about 75 to about 15 mol % of at least one other fluorine-containing monomer. In a preferred embodiment, the binder comprises a mixture of at least two types of vinyl fluoride-based polymers. In another embodiment the binder comprises a vinyl fluoride-based copolymer and at least one other fluorine-based polymer.

The present invention provides a new fluoropolymer resin binder that has a higher bonding capability than the conventional binders, reduces the delamination of the active mass in the battery fabrication process and shows improved adhesion strength and electrochemical stability

### DETAILED DESCRIPTION OF THE INVENTION

The present invention relates to vinyl fluoride-based copolymer binders having improved properties required of electrode binders, such as adhesion strength and flexibility. The vinyl fluoride-based copolymers and their preparation used in forming the binders of the present invention are fully disclosed in U.S. Pat. Nos. 6,403,303 B1; 6,271,303 B1 and 6,242,547 (Uschold).

The vinyl fluoride-based copolymer of the present invention preferably contains about 25 to about 85 mol % of the vinyl fluoride component. In a preferred embodiment the vinyl fluoride-based copolymer comprises about 25 to about 85 mol % vinyl fluoride and about 75 to about 15 mol % of at least one fluorine-containing monomer selected from the group consisting of vinylidene fluoride, tetrafluoroethylene, trifluoroethylene, chlorotrifluoroethylene, fluorinated vinyl ethers, fluorinated alkyl acrylates/methacrylates, perfluoroolefins having 3-10 carbon atoms, perfluoro C₁-C₈ alkyl ethylenes and fluorinated dioxoles.

In another preferred embodiment, binder of the present invention binder comprises a mixture of at least two types of vinyl fluoride-based copolymers.

In especially preferred embodiments, the vinyl fluoride-based copolymer comprises at least one copolymer selected from vinyl fluoride-tetrafluoroethylene copolymer, vinyl fluoride-tetrafluoroethylene-hexafluoropropylene copolymer, vinyl fluoride-tetrafluoroethylene-perfluorobutylethylene copolymer.

In another embodiment of the invention, the binder is preferably a mixture of a vinyl fluoride-based copolymer and at least one other fluorine-based polymer. Preferably, the fluorine-based polymer is at least one polymer selected from a homopolymer or a copolymer prepared from monomers of vinylidene fluoride, tetrafluoroethylene, trifluoroethylene, chlorotrifluoroethylene, fluorinated vinyl ethers, fluorinated alkyl acrylates/methacrylates, perfluoroolefins having 3-10 carbon atoms, perfluoro C₁-C₈ alkyl ethylenes and fluorinated dioxoles.

A preferable method for using the vinyl fluoride-based copolymer binder is to prepare a dispersion by dispersing the vinyl fluoride-based copolymer in organic solvents or water. Another embodiment for preparing the vinyl fluoride-based copolymer binder is to prepare a solution of the vinyl based polymer in organic solvents. Preferred organic solvents are selected from N-methyl-2-pyrrolidone, γ-butyrolactone, N,N-dimethylformamide, N,N-dimethylacetoamide, dimethylsulfoxide, ketones, nitriles or esters or mixtures thereof.

The vinyl fluoride-based copolymer employed in accordance with the present invention can be used in a similar procedure to the conventional process for using a binder in forming battery electrodes. Specifically, the vinyl fluoride-based copolymer binder is dissolved or dispersed in an organic solvent or water which is then mixed with the active mass and a conductive material to obtain a paste. The paste is coated onto a metal foil, preferably aluminum or copper foil, used as the current collector, The paste is dried, preferably with heat, so that the active mass is bonded to the current collector.

The vinyl fluoride-based copolymer of the present invention is not soluble in polar organic solvents such as propylene carbonate, ethylene carbonate and ethylmethyl carbonate and their mixtures and therefore can be used advantageously as a stable binder in batteries.

The battery active mass that can be bonded with a binder in the present invention is not particularly limited. However, lithium composite oxides such as LiCoO₂, LiNiO₂ or LiMn₂O₄ can be cited as examples of the battery active mass for the anode, and carbonacious materials such as graphite and ketjen black can be cited as examples of the battery active mass for the cathode. Furthermore, aluminum and copper foils can be cited as examples of the current collector of the electrodes. The binder of the present invention may be used for both the anode and cathode.

The binder of the present invention shows higher adhesion strength than the conventional binders of polyvinylidene fluoride. Consequently, a smaller amount of vinyl fluoride-based copolymer binder can be used to achieve equivalent adhesion strength as conventional polyvinylidene fluoride binder. As a result, the use of the binder of the present invention allows the amount of the active mass to be increased when using a smaller amount of the binder, thus allowing for an increase in the battery capacity.

### EXAMPLES

In the present invention, the determination of physical properties and the preparation of samples are carried out by use of the following equipment:

Melting Point:

The melting point is measured by use of a differential scanning calorimeter (Pyris 1 available from PerkinElmer) at a temperature increase rate of 10° C./min, and the peak is taken as the melting point.

Adhesion Strength:

The adhesion strength of the aluminum foil used for the binder is measured by use of TENSILON (UTM-1T available from Toyo Baldwin) at the crosshead speed of 50 mm/min and the load cell of 5 kg.

Cyclic Voltammetry:

Cyclic voltammetry is measured under an atmosphere of nitrogen by using an aluminum foil on which a paste obtained by mixing the vinyl fluoride-based copolymer mixed with organic solvent and carbon (ketjen black), is coated and dried as the test electrode, Pt wire as the counter electrode, Ag/Ag⁺⁺ (for an organic solvent, 0.7 V/SHE) as the reference electrode and 1 mol/liter of LiPF₆ (ethylene carbonate+ethylmethyl carbonate mixed solvent: 1:1 by weight) as the electrolytic solution. The scanning range is 0.00 to 5.00 V (125 cycles), and the scanning rate is 0.10 V/s. The current values at 3.50 V in each cycle is compared, and the electrochemical stability of the electrodes is compared in terms of the extent of a decrease in current.

Raw Materials:

The vinyl fluoride-based copolymer powder (0.2 μm in average particle size) that has composition and melting point shown in Tables 1 and 2 is used in the Examples.

Examples and Comparative Examples of the present invention are explained below. It should be noted that the Examples use the vinyl fluoride-based copolymer as the binder and the Comparative Examples use PVDF as the binder. However, the Examples are examples of the present invention, and the present invention is not limited to these Examples.

### EXAMPLES 1 TO 5, COMPARATIVE EXAMPLE 1

Adhesion Strength Evaluation Tests:

After preparing an organosol of resin by mixing 5 wt % of the vinyl fluoride-based copolymer shown in Table 1 or PVDF powder with an organic solvent, 5 wt % of ketjen black are mixed to form a paste. The paste is coated on the frosted side of an aluminum foil 15 μm in thickness (5 cm×10 cm), the coated side of the aluminum foil is sandwiched with another aluminum foil of the same size, and the coated paste is spread manually by means of a film applicator. The thickness of the sample is 120 μm. The coated sheet is dried in a vacuum dryer (LCV-232 available from Tabai Espec) at 190 degree C. for 3 hours. After that, a test specimen, 1 cm×5 cm, is cut out and used for the adhesion strength test.

Adhesion strength is determined by peeling strength test in the 180-degree direction. Results are shown in Table 1. The adhesion strength of the test specimen is compared with a test specimen prepared under the same conditions using PVDF used as the conventional binder. The comparison indicates that the vinyl fluoride-based copolymer shows considerably higher adhesion strength than PVDF.

TABLE 1
Adhesion Strength of Mixture of Vinyl Fluoride-based Copolymer

| | | VF | TFE | Melting | Polymer | Solvent | Peeling |
|---|---|---|---|---|---|---|---|
| | Sample | mol % | mol % | point (° C.) | conc. (wt %) | (wt %) | strength (g) |
| Ex. | | | | | | | |
| 1 | A | 59.6 | 40.4 | 195.7 | 5 | MA-DMA-NMP | 38.4 |
| | | | | | | (46.9:42.3:10.8) | |
| 2 | B | 64.0 | 36.0 | 183.7 | 5 | MA-DMA-NMP | 42.1 |
| | | | | | | (51.9:38.3:9.7) | |
| 3 | C | 69.1 | 30.9 | 180.7 | 5 | acetone-NMP | 32.4 |
| | | | | | | (50.0:50.0) | |
| 4 | C | 69.1 | 30.9 | 180.7 | 5 | MA-DMA | 34.3 |
| | | | | | | (46.8:53.2) | |
| 5 | D | 74.4 | 25.6 | 187.5 | 5 | MA-DMA | 56.9 |
| | | | | | | (32.0:68.0) | |
| Comp. Ex. | | | | | | | |
| 1 | PVDF | / | / | / | 5 | NMP | 9.9 |

NMP: N-methyl-2-pyrrolidone,
MA: Methyl acetate,
DMA: N,N-dimethylacetoamine
VF: Vinyl fluoride,
TFE: Tetrafluoroethylene,
VDF: polyvinylidene fluoride

### ADHESION STRENGTH EVALUATION TEST (EXAMPLES 6 TO 8)

The adhesion strength of a mixture of two types of vinyl fluoride-based copolymer is evaluated by using the method used in Examples 1 to 5 and Comparative Example 1. Results are shown in Table 2. It can be seen from Table 2 that the mixture of Samples D and E (80/20%) of vinyl fluoride-based copolymer shows the highest adhesion strength.

TABLE 2
Adhesion Strength of Mixture of Vinyl Fluoride-based Copolymer

| | Composition | | Polymer | | Peeling |
|---|---|---|---|---|---|
| | Sample | Sample | conc. | Solvent | strength |
| | D | E* | (wt %) | (wt %) | (g) |
| Ex. | | | | | |
| 6 | 90% | 10% | 5 | MA-DMA | 63.8 |
| | | | | (32.0:68.0) | |
| 7 | 80% | 20% | 5 | MA-DMA | 80.6 |
| | | | | (32.0:68.0) | |
| 8 | 70% | 30% | 5 | MA-DMA | 30.8 |
| | | | | (32.0:68.0) | |
| Comp. | | | | | |
| Ex. . | | | | | |
| 1 | PVDF | / | 5 | NMP | 9.9 |

NMP: N-methyl-2-pyrrolidone,
MA: Methyl acetate,
DMA: N,N-dimethylacetoamine
*Sample E: VF/TFE/HFP(hexafluoropropylene) = 69.8/22.8/7.4 copolymer

### EXAMPLES 9 TO 10, COMPARATIVE EXAMPLES 2 TO 3

Electrochemical Test:

The paste used in the adhesion strength test is coated on the end of one side of an aluminum foil 15 μm in thickness (0.5 cm×5 cm) and dried under the conditions of 190 degree C. and 3 hours. This sample is used as the test electrode, and the stability of the electrode is determined by cyclic voltammetry. Results are shown in Table 3.

A comparison of current value at 3.50 V in each cycle indicates a decrease in current in both of the Examples and the Comparative Examples. The reason for this is assumed to be that the LiPF₆ in the electrolytic solution fluorinated the aluminum foil forming an inactive film with low electrical conductivity, causing a increase in resistance. However, there is a significant difference in the tendency toward such decrease. With PVDF, current decreases to about 30% in the second cycle, continues to fall to several percent thereafter and becomes practically zero after 121 cycles. However, with the electrode using the vinyl fluoride-based copolymer as the binder, current decreases to approximately 80% in the second cycle and shows a value of approximately 25% even after 121 cycles, indicating that the decrease in current is suppressed in this electrode. These results suggest that the use of the vinyl fluoride-based copolymer enables the current collector and the carbon to maintain better contact. Therefore, the vinyl fluoride-based copolymer makes the formation of more electrochemically stable electrodes possible.

TABLE 3
Results of Cyclic Voltammetry Test
on Vinyl Fluoride-based Copolymer

| | | | | | | Current |
|---|---|---|---|---|---|---|
| | | | | | | retention |
| | | | | Coating | | rate (%) |
| | | | | amount on | | [Initial |
| | | VF | TFE | electrode | Cycle | current = |
| | Sample | mol % | mol % | (mg) | (times) | 100%] |
| Ex. | | | | | | |
| 9 | D | 74.4 | 25.6 | 0.8 | 0 | 100 |
| | | | | | 2 | 86 |
| | | | | | 16 | 53 |
| | | | | | 121 | 25 |
| 10 | D | 74.4 | 25.6 | 0.9 | 0 | 100 |
| | | | | | 2 | 76 |
| | | | | | 16 | 39 |
| | | | | | 121 | 20 |
| Comp. | | | | | | |
| Ex. | | | | | | |
| 2 | PVDF | / | / | 0.4 | 0 | 100 |
| | | | | | 2 | 27 |
| | | | | | 16 | 3 |
| | | | | | 121 | 0 |
| 3 | PVDF | / | / | 0.6 | 0 | 100 |
| | | | | | 2 | 13 |
| | | | | | 16 | 3 |
| | | | | | 121 | 0 |

According to the present invention, electrodes that suppress the delamination of the active mass in a battery such as a lithium-ion secondary battery and have better electrochemical stability, can be prepared by using the vinyl fluoride-based copolymer as the binder.

What is claimed is:

1. A binder for a battery electrode comprising a vinyl fluoride-based copolymer.

2. The binder of claim 1 wherein the binder comprises a mixture of at least two types of vinyl fluoride-based copolymers.

3. The binder of claim 1 wherein the binder comprises a vinyl fluoride-based copolymer and a fluorine-based polymer which is at least one selected from a homopolymer or a copolymer prepared from monomers selected from the group consisting of vinylidene fluoride, tetrafluoroethylene, trifluoroethylene, chlorotrifluoroethylene, fluorinated vinyl ethers, fluorinated alkyl acrylates/methacrylates, perfluoroolefins having 3-10 carbon atoms, perfluoro C₁-C₈ alkyl ethylenes and fluorinated dioxoles

4. The binder of claim 1 wherein the vinyl fluoride-based copolymer comprises about 25 to about 85 mol % vinyl fluoride and about 75 to about 15 mol % of at least one fluorine-containing monomer selected from the group consisting of vinylidene fluoride, tetrafluoroethylene, trifluoroethylene, chlorotrifluoroethylene, fluorinated vinyl ethers, fluorinated alkyl acrylates/methacrylates, perfluoroolefins having 3-10 carbon atoms, perfluoro C₁-C₈ alkyl ethylenes and fluorinated dioxoles.

5. The binder of claim 1 wherein said vinyl fluoride-based copolymer is at least one copolymer selected from vinyl fluoride-tetrafluoroethylene copolymer, vinyl fluoride-tetrafluoroethylene-hexafluoropropylene copolymer, vinyl fluoride-tetrafluoroethylene-perfluorobutylethylene copolymer.

6. The binder of claim 1 wherein the vinyl fluoride-based copolymer is dispersed in water or an organic solvent to form a dispersion.

7. The binder of claim 1 wherein said wherein said vinyl fluoride-based polymer is dissolved in an organic solvent to form a solution.

8. The binder of claim 6 wherein said organic solvent is selected from the group consisting of N-methyl-2-pyrrolidone, γ-butyrolactone, N,N-dimethylformamide, N,N-dimethyl acetamide, dimethyl sulfoxide, ketones, nitrites, and esters.

9. The binder of claim 7 wherein said organic solvent is selected from the group consisting of N-methyl-2-pyrrolidone, γ-butyrolactone, N,N-dimethylformamide, N,N-dimethyl acetamide, dimethyl sulfoxide, ketones, nitriles, and esters.
